(19) United States
(12) Patent Application Publication
(10) Pub. No.: US 2007/0191480 A1
(43) Pub. Date: Aug. 16, 2007

(54) Gycol Ether Miticides and Anti-Allergen Treatments

(76) Inventors: Shona L. Nelson, Oakland, CA (US); Steve Bromberg, Oakland, CA (US); Adam F. Gross, Oakland, CA (US)

Correspondence Address: THE CLOROX COMPANY, P.O. BOX 24305, OAKLAND, CA, 94623-1305, US

(21) Appl. No.: 11/694,054

(22) Filed: Mar. 30, 2007

Related U.S. Application Data
(62) Division of application No. 10/817,528, filed on Apr. 2, 2004.

(51) Int. Cl. A01N 31/02; C11D 3/386

(52) U.S. Cl. 514/529; 514/723; 510/320

(57) ABSTRACT

The present invention encompasses a cleaning composition and method for controlling dust mites and allergens using glycol ether, glycol ether ester or a combination thereof. The cleaning composition preferably contains a hydrophobic glycol ether and/or glycol ether ester solution present at a level of about 0.01% to 20% by weight and is an effective miticide with a kill rate of at least 50% after 30 minutes. The cleaning composition may optionally contain: surfactants, corrosion inhibitors, soil and stain resist agents, builder and buffering agents, and a propellant for delivering the composition in aerosol form.

### FIELD OF THE INVENTION

The present invention relates to cleaning methods and compositions, which act as an effective miticide and anti-allergen treatment for both soft and hard surfaces. The compositions may be applied to an infested surface in either vapor or liquid form. There are numerous methods of applying the composition to infested surfaces, including, but not limited to: aerosol, vaporized application, immersion in a dilute solution, spray or other localized delivery means directly to the affected surface.

### BACKGROUND OF THE INVENTION

Miticide and anti-allergen compositions based on known disinfectants such as bleach, quaternary ammonium compounds, essential oils or the like are commonly used in numerous cleaning compositions. A variety of chemical disinfecting agents have been developed to disinfect household, commercial and institutional settings in carpets, clothing, linens, and hard surfaces as well, where organisms, mites and various allergens commonly accumulate. While these common disinfectants may be effective in some circumstances there are also significant drawbacks to these disinfectants.

Some common problems are that the disinfecting activity for the compositions are short-lived; they stain or degrade some surfaces; they may leave a residue that detracts from the physical appearance of the treated surface; they may leave residual products in the treated material that may irritate people using the treated materials; they have an undesirable odor; or they are not safe for frequent household or commercial use. For example, chlorine bleaches such as aqueous sodium hypochlorite in high enough concentrations have long been recognized as being effective against all types of microorganisms, but the sensory irritation for the chlorine smell of the bleach makes it an undesirable for routine cleaning, particularly for indoor areas. In addition, the hypochlorites can stain or degrade some surfaces. Similarly, quaternary ammonium compounds are also know to be powerful skin and eye irritants and therefore are not desirable for frequent use indoors.

In addition to the common disinfectants, synthetic chemical pesticides have also provided an effective means of pest control. However, it has become increasingly apparent that the widespread use of chemical pesticides has caused detrimental health and environmental effects. With the rising concern over the harmful effects of pesticides many products have been removed from the marketplace and there is an increasing need for safe treatments for mites and other allergens. The use of essential oils as a miticide is well known, but the use of essential oils does have some significant drawbacks such as their strong scent and their potential to be a skin and eye irritant. Accordingly there still is a significant need for an effective miticide and anti-allergen composition for household and commercial use.

### SUMMARY OF THE INVENTION

The present invention encompasses a cleaning composition and method for controlling dust mites and allergens using glycol ether, glycol ether ester or a combination thereof. The cleaning composition preferably contains a hydrophobic glycol ether and/or glycol ether ester solution present at a level of about 0.01% to 20% by weight and is an effective miticide with a kill rate of at least 50% after 30 minutes. The cleaning composition may optionally contain: surfactants, corrosion inhibitors, soil and stain resist agents, builder and buffering agents, and a propellant for delivering the composition in aerosol form. In one embodiment of the invention, the cleaning composition may be essentially free of conventional antibacterial agents including peroxygen and chlorine bleaches, quaternary ammonium compounds, alcohols, aldehydes, parabens, organic acids, peroxy acids and phenolic compounds.

In one aspect of the invention, the material to be treated may be treated with the cleaning composition and then after a short period of time is scrubbed by a cleaning substrate and finally any remaining cleaning composition is vacuumed or wiped away from the treated material. The cleaning composition can be used to clean various surfaces and materials such as: carpets, floors, ceilings, walls, counters, linens and clothing.

In another aspect of the invention, the material to be treated may be immersed in the cleaning composition for a set period of time and then washed clean. For this aspect of the invention, the cleaning composition may be used in a laundry machine, as part of a dry cleaning process or a pretreatment for laundry prior to washing.

In a further aspect, the cleaning composition may be evaporated or vaporized into the air to treat materials in an enclosed area or to be sprayed directly onto the surface to be treated. The composition may be delivered to the material by an aerosol spray with the aid of a propellant. Alternatively, the cleaning composition may be applied to a dispensing material such as a dryer sheet or sachet, where the composition is vaporized when it is used in a conventional laundry drier. Other vaporizing devices such as plug-in emanators or foggers may also be used.

### DETAILED DESCRIPTION OF THE INVENTION

The cleaning composition and method of the present invention can be used to clean carpets, linens, clothing, floors, windows, bathrooms, showers, tubs, toilets, interior and exterior surfaces of automobiles, outdoor surfaces, and other soft and hard surfaces.

Cleaning Composition

The first component of the present invention is a glycol ether and/or glycol ether ester solution. Suitable glycol ethers and glycol ether esters include propylene glycol methyl ether acetate (available as Dowanol® PMA), dipropylene glycol methyl ether acetate (available as Dowanol® DPMA), propylene glycol n-butyl ether (available as Dowanol® PnB), dipropylene glycol n-butyl ether (available as Dowanol® TPnB), propylene glycol phenol ether (available as Dowanol® PPh), ethylene glycol monobutyl ether (available as Dowanol® EB), diethylene glycol monobutyl ether (available as Dowanol® DB), ethylene glycol monohexyl ether (available as Hexyl Cellosolve®), diethylene glycol monohexyl ether (available as Hexyl Carbitol®), hydroxy-polyethers (available as Ecosoft Solvents®), ethylene glycol phenyl ether (available as Dowanol® Eph), ethylene glycol phenol ether (available as Dalpad a Coalescing Agent), ethylene glycol n-butyl ether acetate (available as Butyl Cellosolve Acetate®), diethylene glycol n-butyl ether acetate (available as Butyl Carbitol Acetate®), dipropylene glycol n-propyl ether (available as Dowanol® DPnP) and mixtures thereof.

In the present invention, the glycol ethers and/or glycol ether esters are generally present in the range form about 0.01% to about 10.0% by weight of the total solution. The glycol ether and/or glycol ether ester solution is preferably hydrophobic. The glycol ether component or mixture will preferably be about 1% to 8% by weight. In one embodiment of the invention, the solution will contain about 0.01% to 8.0% dipropylene glycol n-propyl ether (available as Dowanol® DPnP) as well as another glycol ether or glycol ether ester. The majority of the solution is typically water, but it may contain other suitable solvents and additives. Other suitable solvents, capable of solubilizing hydrophobic materials, include: alkanols, diols, alkyl ethers of alkylene glycols, alkylene glycol ethers, polyalkylene glycols, short chain carboxylic acids, short chain esters, isoparaffinic hydrocarbons, mineral spirits, alkylaromatics, terpenes, terpene derivatives, terpenoids, formaldehydes, and pyrrolidones.

Compositions of the present invention typically have a pH of about 5 to 10 and more preferably from 5.8 to about 9.5. The pH may be adjusted by conventional buffering and pH adjusting agents. These agents include, but are not limited to, organic acids, mineral acids, alkali metal and alkaline earth salts of silicate, metasilicate, polysilicate, borate, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and 2-amino-2methylpropanol.

The cleaning compositions in the present invention are typically water-based, but the choice of the cleaning composition may change depending on the surface to be cleaned. Water should be present at an amount less than 99%, more preferably less than about 96%, and most preferably less than about 93% of the cleaning composition. As is apparent, concentrated forms of the cleaning composition can have significantly less water.

The cleaning composition may comprise additional and/or other components from the following listing, including surfactants, propellants, antimicrobial agents, corrosion inhibitors, soil and stain resist agents, builder and buffering agents, and other additional adjuncts.

A. Surfactant

The cleaning composition preferably contains one or more surfactants selected from anionic, nonionic, cationic, ampholytic, amphoteric and zwitterionic surfactants and mixtures thereof. In a preffered embodiment of the invention, the cleaning composition contains about 1% Stepanol® WAC (sodium laurel sulfate) by weight. Surfactants, among other things, aid in the removal of soil from carpets. Suitable anionic, nonionic, ampholytic, and zwitterionic surfactants are disclosed in U.S. Pat. No. 3,929,678 to Laughlin and in Heuring, Surface Active Agents and Detergents, Vol. I by Schwartz, Perry and Berch; suitable cationic surfactants are disclosed in U.S. Pat. No. 4,259,217 to Murphy. Where present, ampholytic, amphotenic and zwitteronic surfactants are generally used in combination with one or more anionic and/or nonionic surfactants. The surfactants are preferably present at a level of from 0.01% to 5% and preferably from 0.1% to 1% of the composition. (All percentages herein are based on weight unless otherwise noted.)

In preferred cleaning compositions, an anionic surfactant useful for detersive purposes can be added. These can include salts (including, for example, sodium, potassium, ammonium, and substituted ammonium salts such as mono-, di- and triiethanolamine salts) of the anionic sulfate, sulfonate, carboxylate and sarcosinate surfactants. Anionic sulfate and sulfonate surfactants are preferred. The anionic surfactants is preferably present at a level of from 0.1% to 60%, more preferably from 1 to 40%, and most preferably from 5% to 30%. Preferred are surfactants systems comprising a sulfonate and a sulfate surfactant, preferably a linear or branched alkyl benzene sulfonate and alkyl ethoxylsulfates, as described herein.

Other anionic surfactants include the isethionates such as the acyl isethionates, N-acyl taurates, fatty acid amides of methyl tauride, alkyl succinates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), N-acyl sarcosinates. Resin acids and hydrogenated resin acids are also suitable, such as rosin, hydrogenated rosin, and resin acids and hydrogenated resin acids present in or derived from tallow oil. Anionic sulfate surfactants suitable for use herein include the linear and branched primary and secondary alkyl sulfates, alkyl ethoxysulfates, fatty oleoyl glycerol sulfates, alkyl phenol ethylene oxide ether sulfates, the C₅-C₁₇ acyl-N—(C₁-C₄ alkyl) and —N—(C₁-C₂ hydroxyalkyl)glucamine sulfates, and sulfates of alkylpolysacchanides such as the sulfates of alkylpolygluco side (the nonionic nonsulfated compounds being described herein). Alkyl sulfate surfactants are preferably selected from the linear and branched primary C₁₀-C₁₈ alkyl sulfates, more preferably the C₁₁-C₁₅ branched chain alkyl sulfates and the C₁₂-C₁₄ linear chain alkyl sulfates.

Alkyl ethoxysulfate surfactants are preferably selected from the group consisting of the C₁₀-C₁₈ alkyl sulfates which have been ethoxylated with from 0.5 to 20 moles of ethylene oxide per molecule. More preferably, the alkyl ethoxysulfate surfactant is a C₁₁-C₁₈, most preferably C₁₁-C₁₅ alkyl sulfate which has been ethoxylated with from 0. 5 to 7, preferably from 1 to 5, moles of ethylene oxide per molecule. A particularly preferred aspect of the invention employs mixtures of the preferred alkyl sulfate and/or sulfonate and alkyl ethoxysulfate surfactants. Such mixtures are disclosed in WO 93/18124.

Anionic sulfonate surfactants suitable for use herein also include the-salts of C₅-C₂₀ linear alkylbenzene sulfonates, alkyl ester sulfonates, C₆-C₂₂ primary or secondary alkane sulfonates, C₆-C₂₄ olefin sulfonates, sulfonated polycarboxylic acids, alkyl glycerol sulfonates, fatty acyl glycerol sulfonates, fatty oleyl glycerol sulfonates, and any mixtures thereof. Suitable anionic carboxylate surfactants include the alkyl ethoxy carboxylates, the alkyl polyethoxy polycarboxylate surfactants and the soaps (‘alkyl carboxyls’), especially certain secondary soaps as described herein. Suitable alkyl ethoxy carboxylates include those with the formula RO(CH₂CH₂O))ₓCH₂COO³¹ M⁺ wherein R is a C₆ to C₁₈ alkyl group, x ranges from 0 to 10, and the ethoxylate distribution is such that, on a weight basis, the amount of material where x is 0 is less than 20% and M is a cation. Suitable alkyl polyethoxypolycarboxylate surfactants include those having the formula RO—(CHR¹—CHR²—O)—R³ wherein R is a C₆ to C₁₈ alkyl group, x is from 1 to 25, R¹ and R² are selected from the group consisting of hydrogen, methyl acid radical, succinic acid radical, hydroxysuccinic acid radical, and mixtures thereof, and R³ is selected from the group consisting of hydrogen, substituted or unsubstituted hydrocarbon having between 1 and 8 carbon atoms, and mixtures thereof.

Suitable soap surfactants include the secondary soap surfactants which contain a carboxyl unit connected to a secondary carbon. Preferred secondary soap surfactants for use herein are water-soluble members selected from the group consisting of the water-soluble salts of 2-methyl-1-undecanoic acid, 2-ethyl-1-decanoic acid, 2-propyl-1-nonanoic acid, 2-butyl-1-octanoic acid and 2-pentyl-1-heptanoic acid. Certain soaps may also be included as suds suppressors.

Other suitable anionic surfactants are the alkali metal sarcosinates of formula R—CON(R¹)CHCOOM, wherein R is a C₅-C₁₇ linear or branched alkyl or alkenyl group, R¹ is a C₁-C₄ alkyl group and M is an alkali metal ion. Preferred examples are the myristyl and oleoyl methyl sarcosinates in the form of their sodium salts.

Essentially any alkoxylated nonionic surfactants can be employed. The ethoxylated and propoxylated nonionic surfactants are preferred. Preferred alkoxylated surfactants can be selected from the classes of the nonionic condensates of alkyl phenols, nonionic ethoxylated alcohols, nonionic ethoxylated/propoxylated fatty alcohols, nonionic ethoxylate/propoxylate condensates with propylene glycol, and the nonionic ethoxylate condensation products with propylene oxide/ ethylene diamine adducts.

The condensation products of aliphatic alcohols with from 1 to 25 moles of alkylene oxide, particularly ethylene oxide and/or propylene oxide, are suitable. The alkyl chain of the aliphatic alcohol can either be straight or branched, primary or secondary, and generally contains from 6 to 22 carbon atoms. Particularly preferred are the condensation products of alcohols having an alkyl group containing from 8 to 20 carbon atoms with from 2 to 10 moles of ethylene oxide per mole of alcohol.

Polyhydroxy fatty acid amides suitable for use are those having the structural formula R²CONR¹Z wherein: R¹ is H, C₁-C₄ hydrocarbyl, 2-hydroxyethyl, 2-hydroxypropyl, ethoxy, propoxy, or a mixture thereof, preferable C₁-C₄ alkyl, more preferably C₁ or C₂ alkyl, most preferably C₁ alkyl (i.e., methyl); and R² is a C₅-C₃₁ hydrocarbyl, preferably straight-chain C₅-C₁₉ alkyl or alkenyl, more preferably straight-chain C₉-C₁₇ alkyl or alkenyl, most preferably straight-chain C₁₁-C₁₇ alkyl or alkenyl, or mixture thereof-, and Z is a polyhydroxyhydrocarbyl having a linear hydrocarbyl chain with at least 3 hydroxyls directly connected to the chain, or an alkoxylated derivative (preferably ethoxylated or propoxylated) thereof Z preferably will be derived from a reducing sugar in a reductive amination reaction; more preferably Z is a glycityl.

Suitable fatty acid amide surfactants include those having the formula: R¹CON(R²)₂ wherein R¹ is an alkyl group containing from 7 to 21, preferably from 9 to 17 carbon atoms and each R² is selected from the group consisting of hydrogen, C₁-C₄ alkyl, C₁-C₄ hydroxyalkyl, and —(C₂H₄₀)ₓH, where x is in the range of from 1 to 3.

Suitable alkylpolysaccharides are disclosed in U.S. Pat. No. 4,565,647 to Llenado, having a hydrophobic group containing from 6 to 30 carbon atoms and a polysaccharide, e.g., a polyglycoside, hydrophilic group containing from 1.3 to 10 saccharide units.

Preferred alkylpolyglycosides have the formula: R²O(CₙH₂ₙO)ₜ(glycosyl). wherein R² is selected from the group consisting of alkyl, alkylphenyl, hydroxyalkyl, hydroxyalkylphenyl, and mixtures thereof in which the alkyl groups contain from 10 to 18 carbon atoms; n is 2 or 3; t is from 0 to 10, and x is from 1.3 to 8. The glycosyl is preferably derived from glucose.

Suitable amphoteric surfactants include the amine oxide surfactants and the alkyl amphocarboxylic acids. Suitable amine oxides include those compounds having the formula R³(OR⁴)_{X}NO(R⁵ )₂ wherein R³ is selected from an alkyl, hydroxyalkyl, acylamidopropoyl and alkyl phenyl group, or mixtures thereof, containing from 8 to 26 carbon atoms; R⁴ is an alkylene or hydroxyalkylene group containing from 2 to 3 carbon atoms, or mixtures thereof, x is from 0 to 5, preferably from 0 to 3; and each R⁵ is an alkyl or hydroxyalkyl group containing from 1 to 3, or a polyethylene oxide group containing from 1 to 3 ethylene oxide groups. Preferred are C₁₀-C₁₈ alkyl dimethylamine oxide, and C₁₀-₁₈ acylamido alkyl dimethylamine oxide. A suitable example of an alkyl aphodicarboxylic acid is MIRANOL C₂M Conc. manufactured by Miranol, Inc., Dayton, N.J.

Zwitterionic surfactants can be broadly described as derivatives of secondary and tertiary amines, derivatives of heterocyclic secondary and tertiary amines, or derivatives of quaternary ammonium, quaternary phosphoniurn or tertiary sulfonium compounds. Betaine and sultaine surfactants are exemplary zwittenionic surfactants.

Suitable betaines are those compounds having the formula R(R¹)₂N⁺R²COO⁻ wherein R is a C₆-C₁₈ hydrocarbyl group, each R¹ is typically C₁-C₃ alkyl, and R² is a C₁-C₅ hydrocarbyl group. Preferred betaines are C₁₂-C₁₈ dimethyl-ammonio hexanoate and the C₁₀-C₁₈ acylamidopropane(or ethane)dimethyl(or diethyl)betaines. Complex betaine surfactants can also be used.

Suitable cationic surfactants include the quaternary ammonium surfactants. Preferably the quaternary ammonium surfactant is a mono C₆-C₁₆, preferably C₆-C₁₀ N-alkyl or alkenyl ammonium surfactants wherein the remaining N positions are substituted by methyl, hydroxyethyl or hydroxypropyl groups. Preferred cationic surfactants include mono-alkoxylated and bis-alkoxylated amines.

Another suitable group of cationic surfactants are cationic ester surfactants. The cationic ester surfactant is a, preferably water dispersible, compound having surfactant properties comprising at least one ester (i.e., —COO—) linkage and at least one cationically charged group. Suitable cationic ester surfactants, including choline ester surfactants, have for example been disclosed in U.S. Pat. Nos. 4,228,042 and 4,260,529 both to Letton and U.S. Pat. No. 4,239,660 to Kingry.

The ester linkage and cationically charged group can be separated from each other in the surfactant molecule by a spacer group consisting of a chain comprising at least three atoms (i.e. of three atoms chain length), preferably from three to eight atoms, more preferably from three to five atoms, most preferably three atoms. The atoms forming the spacer group chain are selected from the group consisting, of carbon, nitrogen and oxygen atoms and any mixtures thereof, with the proviso that any nitrogen or oxygen atom in said chain connects only with carbon atoms in the chain. Thus spacer groups having, for example, —O—O— (i.e. peroxide), —N—N—, and —N—O— linkages are excluded, whilst spacer groups having, for example —CH₂—O—CH₂— and —CH₂—NH—CH₂— linkages are included. In a preferred aspect the spacer group chain comprises only carbon atoms, most preferably the chain is a hydrocarbyl chain.

Other suitable surfactants are cationic mono-alkoxylated amine surfactants preferably of the general formula: R¹R²R³N⁺ApR⁴X⁻ wherein R¹ is an alkyl or alkenyl moiety containing from about 6 to about 18 carbon atoms, preferably 6 to about 16 carbon atoms, most preferably from about 6 to about 14 carbon atoms; R² and R³ are each independently alkyl groups containing from one to about three carbon atoms, preferably methyl, most preferably both R² and R³ are methyl groups; R⁴ is selected from hydrogen (preferred), methyl and ethyl; X⁻ is an anion such as chloride, bromide, methylsulfate, sulfate, or the like, to provide electrical neutrality; A is a alkoxy group, especially a ethoxy, propoxy or butoxy group; and p is from 0 to about 30, preferably 2 to about 15, most preferably 2 to about 8. Preferably the AₚR⁴ group in the formula has p=1 and is a hydroxyalkyl group, having no greater than 6 carbon atoms whereby the —OH group is separated from the quaternary ammonium nitrogen atom by no more than 3 carbon atoms. Particularly preferred AₚR⁴ groups are —CH₂CH₂—OH, —CH₂CH₂CH₂—OH, —CH₂CH(CH₃)—OH and —CH(CH₃)CH₂—OH, with —CH₂CH₂—OH being particularly preferred. Preferred R^{‘}groups are linear alkyl groups. Linear R¹ groups having from 8 to 14 carbon atoms are preferred.

Another highly preferred cationic mono-alkoxylated amine surfactants have the formula R¹(CH₃)(CH₃)N⁺(CH₂CH₂₀)₂₋₅HX⁻ wherein R¹ is C₁₀-C₁₈ hydrocarbyl and mixtures thereof, especially C₁₀-C₁₄ alkyl, preferably C₁₀ and C₁₂ alkyl, and X is any convenient anion to provide charge balance, preferably chloride or bromide.

As noted, compounds of the foregoing type include those wherein the ethoxy (CH₂CH_{2O}) units (EO) are replaced by butoxy, isopropoxy [CH(CH₃)CH_{2O}] and [CH₂CH(CH₃)O] units (i-Pr) or n-propoxy units (Pr), or mixtures of EO and/or Pr and/or i-Pr units.

The level of the cationic mono-alkoxylated amine surfactants is preferably from 0. 1% to 20%, more preferably from 0.2% to 7%, and most preferably from 0.3% to 3.0%.

The cationic bis-alkoxylated amine surfactant preferably has the general formula: R¹R²N⁺ApR³A′qR⁴X⁻ wherein R¹ is an alkyl or alkenyl moiety containing from about 8 to about 18 carbon atoms, preferably 10 to about 16 carbon atoms, most preferably from about 10 to about 14 carbon atoms; R² is an alkyl group containing from one to three carbon atoms, preferably methyl; R³ and R⁴ can vary independently and are selected from hydrogen (preferred), methyl and ethyl, X⁻ is an anion such as chloride, bromide, methylsulfate, sulfate, or the like, sufficient to provide electrical neutrality. A and A′ can vary independently and are each selected from C₁-C₄ alkoxy, especially ethoxy, (i.e., —CH₂CH₂O—), propoxy, butoxy and mixtures thereof, p is from 1 to about 30, preferably 1 to about 4 and q is from 1 to about 30, preferably 1 to about 4, and most preferably both p and q are 1.

Highly preferred cationic bis-alkoxylated amine surfactants further include those of the formula R¹CH3N⁺(CH₂CH₂OH)(CH₂CH₂OH)X⁻ wherein R¹ is C₁₀-C₁₈ hydrocarbyl and mixtures thereof, preferably C₁₀, C₁₂, C₁₄ alkyl and mixtures thereof X⁻ is any convenient anion to provide charge balance, preferably chloride. With reference to the general cationic bis-alkoxylated amine structure noted above, since in a preferred compound R¹ is derived from (coconut) C₁₂-C₁₄ alkyl fraction fatty acids, R² is methyl and AₚR³ and AₚR⁴ are each monoethoxy.

Other useful cationic bis-alkoxylated amine surfactants include compounds of the formula: R¹R²N⁺—(CH₂CH₂O)ₚH—(CH₂CH₂HO)_{q}HX⁻ wherein R¹ is C₁₀-C₁₈ hydrocarbyl, preferably C₁₀-C₁₄ alkyl, independently p is 1 to about 3 and q is 1 to about 3, R² is C₁-C₃ alkyl, preferably methyl, and X⁻ is an anion, especially chloride or bromide.

Other compounds of the foregoing type include those wherein the ethoxy (CH₂CH₂O) units (EO) are replaced by butoxy (Bu) isopropoxy [CH(CH₃)CH₂O] and [CH₂CH(CH₃)O] units (i-Pr) or n-propoxy units. (Pr), or mixtures of EO and/or Pr and/or i-Pr units.

B. Propellant

The cleaning composition may be delivered in the form of an aerosol with the aid of a propellant which can comprise, for example, a hydrocarbon, of from 1 to 10 carbon atoms, such as methane, ethane, n-propane, n-butane, isobutane, n-pentane, isopentane, and mixtures thereof. The propellant may also be selected from halogenated hydrocarbons including, for example, fluorocarbons, chlorocarbons, chlorofluorocarbons, and mixtures thereof. (Besides of concerns about the destruction of the stratosphere's ozone layer, the use of fluorocarbons and chlorofluorocarbons is less preferred.) Examples of other suitable propellants are found in P. A. Sanders Handbook of Aerosol Technology (Van Nostrand Reinhold Co.) (1979) 2nd Ed., pgs. 348-353 and 364-367, which are incorporated by reference herein. Further, non-hydrocarbon propellants may be possible, such as carbon dioxide, nitrogen, compressed air, and, possibly, dense or supercritical fluids.

The aerosol formulation, which is the mixture of cleaning composition and propellant, is preferably stored in and dispensed from a pressurized can that is equipped with a nozzle so that an aerosol of the formulation can be readily sprayed onto a surface. In loading the dispenser, the non-propellant components of the aerosol formulation are mixed into a concentrate and loaded into the dispenser first. Thereafter, the liquefied gaseous propellant is inserted before the dispenser is fitted with a nozzle.

A liquefied gas propellant mixture comprising about 85% isobutane and 15% propane is preferred because it provides sufficient pressure to expel the cleaning composition from the container and provides good control over the nature of the spray upon discharge of the aerosol formulation. Other suitable propellants include compressed carbon dioxide and nitrogen gases. Preferably, the propellants comprises about 1% to 50%, more preferably about 2% to 25%, and most preferably about 5% to 15% of the aerosol formulation.

In one embodiment of the inventions an aerosol formulation may be used for carpet cleaning. The aerosol application of foam cleaner can be very stable up to 5 to 10 minutes. Because this cleaning implement is designed to clean large areas easily, it is preferred that the foam be visible and consumer noticeable, however, it should be easily dispersed. The preferred foam of the invention is stable for only 1 to 2 minutes. A cleaning substrate may be used to rub the cleaning solution into the surface may contain antifoam ingredients that cause the foam to break as the cleaning substrate is moved over the foam. The cleaning substrate may be a brush, pad, rake, sponge, or any other suitable cleaning implement.

The aerosol dispenser is pressurized with a gaseous component that is generally known as a propellant. Common aerosol propellants, e.g., gaseous hydrocarbons such as isobutane, and mixed halogenated hydrocarbons, can be used. Halogenated hydrocarbon propellants such as chlorofluoro hydrocarbons have been alleged to contribute to environmental problems, and are not preferred. When cyclodextrin is present in the carpet cleaning composition for odor control reasons, hydrocarbon propellants are not preferred, because they can form complexes with the cyclodextrin molecules thereby reducing the availability of uncomplexed cyclodextrin molecules for odor absorption. Preferred propellants are compressed air, nitrogen, carbon dioxide, and other inert gases. Commercially available aerosol-spray dispensers are further described in U.S. Pat. No. 3,436,772 to Stebbins and U.S. Pat. No. 3,600,325 to Kaufman et al., both of which are incorporated herein by reference.

Another type of aerosol dispenser that may be employed includes a barrier that separates the cleaning composition from the propellant, e.g., compressed air or nitrogen, which is further described in U.S. Pat. No. 4,260,110 to Werding and incorporated herein by reference. Such a dispenser is available from EP Spray Systems, East Hanover, N.J.

Alternatively, the aerosol spray dispenser can be a self-pressurized non-propellant container having a convoluted liner and an elastomeric sleeve. These self-pressurized dispensers employ a liner/sleeve assembly containing a thin, flexible radially expandable convoluted-plastic liner, which is about 0.010 in. (0.254 mm) to about 0.020 in. (0.508 mm) thick, inside an essentially cylindrical elastomeric sleeve. The liner/sleeve is capable of holding a substantial quantity of cleaning composition product and of causing the product to be dispensed. Suitable self-pressurized spray dispensers are further described in U.S. Pat. Nos. 5,111,971 and 5,232,126 both to Winer and which are herein incorporated by reference.

C. Antimicrobial Agent

An antimicrobial agent can also be included in the cleaning composition. Non-limiting examples of useful quaternary compounds that function as antimicrobial agents include benzalkonium chlorides and/or substituted benzalkonium chlorides, di(C₆-C₁₄)alkyl di short chain (C₁₋₄ alkyl and/or hydroxyalkl)quaternaryammonium salts, N-(3-chloroallyl)hexaminium chlorides, benzethonium chloride, methylbenzethonium chloride, and cetylpyridinium chloride. The quaternary compounds useful as cationic antimicrobial actives are preferably selected from the group consisting of dialkyldimethyl ammonium chlorides, alkyldimethylbenzylammonium chlorides, dialkylmethylbenzylammonium chlorides, and mixtures thereof. Biguanide antimicrobial actives including, but not limited to polyhexamethylene biguanide hydrochloride, p-chlorophenyl biguanide; 4-chlorobenzhydryl biguanide, halogenated hexidine such as, but not limited to, chlorhexidine (1,1′-hexamethylene-bis-5-(4-chlorophenyl biguanide) and its salts are especially preferred. Typical concentrations for biocidal effectiveness of these quaternary compounds, especially in the low-surfactant compositions, range from about 0.001% to about 0.8% and preferably from about 0.005% to about 0.3% of the usage composition. The weight percentage ranges for the biguanide and/or quat compounds in the cleaning composition is selected to disinfect, sanitize, and/or sterilize most common household and industrial surfaces.

Non-quaternary biocides are also useful. Such biocides can include, but are not limited to, alcohols, peroxides, boric acid and borates, chlorinated hydrocarbons, organometallics, halogen-releasing compounds, mercury compounds, metallic salts, pine oil, organic sulfur compounds, iodine compounds, silver nitrate, quaternary phosphate compounds, and phenolics.

These antimicrobial or antifungal materials include water-soluble, film-forming polymers (See, U.S. Pat. No. 6,454,876 to Ochomogo which is incorporated herein by reference), quaternary ammonium compounds and complexes therewith (See, U.S. Pat. Nos. 6,482,392, 6,080,387, 6,284,723, 6,270,754, 6,017,561 and 6,013,615 to Zhou et al. all of which are incorporated herein by reference), essential oils, such as nerolidol (See, U.S. Pat. No. 6,361,787 to Shaheen et al. incorporated by reference), KATHON (See, U.S. Pat. No. 5,789,364 to Sells et al., and U.S. Pat. No. 5,589,448 to Koerner et al., which are incorporated herein by reference), and, possibly, bleaches, such as hydrogen peroxide and alkali metal hypochlorite.

D. Corrosion Inhibitors

Since the canister to dispense the cleaning composition in aerosol form can be made of metal, e.g., tin-plated steel can, it is advantageous to add one or more corrosion inhibitors to prevent or at least reduce the rate of expected corrosion of such a metallic dispenser. Chloride salts, if present, may cause corrosion. Preferred corrosion inhibitors include, for example, sodium nitrite, potassium nitrite, sodium benzoate, potassium benzoate, amine neutralized alkyl acid phosphates and nitroalkanes, amine neutralized alkyl acid phosphates and volatile amines, diethanolamides, amine borates, hydroxylamines, alkanolamines, amine carboxylates, esters, volatile silicones, amines and mixtures thereof. Specific inhibitors include, for example, sodium lauroyl sarcosinate, available from Stepan Company under the trademark MAPROSYL 30, sodium meta silicate, sodium or potassium benzoate, triethanolamine, and morpholine. When employed, the corrosion inhibitor preferably comprises about 0.01% to 5% of the aerosol formulation.

E. Soil and Stain Resist Agents

Soil resist agents resist or repel dirt, oil, or other typically hydrophobic substances from the carpet. Fluorochemical soil-resist agents may include polymers or compounds having pendent or end groups of perfluoroalkyl moieties, fluorosurfactants, or fluoro-intermediates. Examples of some suitable fluorochemical soil-resist agents include ZONYL 7950 and ZONYL 5180, which are available from DuPont. When employed the soil and stain resist agents are preferably present at a level of from 0.01% to 5% and preferably from 0.1 to 1% of the composition

The optional stain-resist agent may also be selected from the group consisting of copolymers of hydrolyzed maleic anhydride with aliphatic alpha olefins, aromatic olefins, or vinyl ethers, poly(vinyl methyl ether/maleic acid) copolymers, homopolymers of methacrylic acid, and copolymers of methacrylic acid. Suitable poly(vinyl methyl ether/maleic acid) copolymers are commercially available, for instance, from ISP Corporation, New York, N.Y. and Montreal, Canada under the product names GANTREZ AN Copolymer (AN-119 copolymer, average molecular weight of 20,000; AN-139 copolymer, average molecular weight of 41,000; AN-149 copolymer, average molecular weight of 50,000; AN-1 69 copolymer, average molecular weight of 67,000; AN-179 copolymer, average molecular weight of 80,000), GANTREZ S (GANTREZ S97, average molecular weight of 70,000), and GANTREZ ES (ES-225, ES-335, ES-425, ES-435), GANTREZ V (V-215, V-225, V-425). Preferably, the stain-resist agent is ZELAN 338, which is available from DuPont.

Suitable anti-resoiling polymers also include soil suspending polyamine polymers. Particularly suitable polyamine polymers are alkoxylated polyamines including so-called ethoxylated polyethylene amines, i.e., the polymerized reaction product of ethylene oxide with ethyleneimine. Suitable ethoxylated polyethylene amines are commercially available from Nippon Shokubai CO., LTD under the product names ESP-0620A (ethoxylated polyethylene amine wherein n=2 and y=20) or from BASF under the product names ES-8165 and from BASF under the product name LUTENSIT K-187/50.

Suitable anti-resoiling polymers also include polyamine N-oxide polymers. The polyamine N-oxide polymer can be obtained in almost any degree of polymerization. Typically, the average molecular weight is within the range of 1,000 to 100,000; more preferred 5,000 to 100,000; most preferred 5,000 to 25,000. Suitable poly vinyl pyridine-N-oxide polymers are commercially available from Hoechst under the trade name of Hoe S 4268, and from Reilly Industries Inc. under the trade name of PVNO.

Furthermore, suitable anti-resoiling polymers include N-vinyl polymers. Suitable N-vinyl polymers include polyvinyl pyrrolidone polymers, co-polymers of N-vinylpyrrolidone and N-vinylimidazole, co-polymers of N-vinylpyrrolidone and acrylic acid, and mixtures thereof. Suitable co-polymers of N-vinylpyrrolidone and N-vinylimidazole are commercially available from BASF, under the trade name of Sokalan PG55. Suitable vinylpyrrolidone homopolymers, are commercially available from BASF under the trade names LUVISKOL K15 (viscosity molecular weight of 10,000), LUVISKOL K25 (viscosity molecular weight of 24,000), LUVISKOL K30 (viscosity molecular weight of 40,000), and other vinyl pyrrolidone homopolymers known to persons skilled in the detergent field (see for example EP-A-262,897 and EP-A-256,696). Suitable co-polymers of N-vinylpyrrolidone and acrylic acid are commercially available from BASF under the trade name SOKALAN PG 310. Preferred N-vinyl polymers are polyvinyl pyrrolidone polymers, co-polymers of N-vinylpyrrolidone and N-vinylimidazole, co-polymers of N-vinylpyrrolidone and acrylic acid, and mixtures thereof, even more preferred are polyvinyl pyrrolidone polymers.

Suitable anti-resoiling polymers also include soil suspending polycarboxylate polymers. Any soil suspending polycarboxylate polymer known to those skilled in the art can be used according to the present invention such as homo- or co-polymeric polycarboxylic acids or their salts including polyacrylates and copolymers of maleic anhydride or/and acrylic acid and the like. Indeed, such soil suspending polycarboxylate polymers can be prepared by polymerizing or copolymerizing suitable unsaturated monomers, preferably in their acid form. Unsaturated monomeric acids that can be polymerized to form suitable polymeric polycarboxylates include acrylic acid, maleic acid (or maleic anhydride), fumaric acid, itaconic acid, aconitic acid, mesaconic acid, citraconic acid and methylenernalonic acid. The presence in the polymeric polycarboxylates herein of monomeric segments, containing no carboxylate radicals such as vinylmethyl ether, styrene, ethylene, etc. is suitable provided that such segments do not constitute more than 40%.

Particularly suitable polymeric polycarboxylates to be used herein can be derived from acrylic acid. Such acrylic acid-based polymers which are useful herein are the water-soluble salts of polymerized acrylic acid. The average molecular weight of such polymers in the acid form preferably ranges from 2,000 to 10,000, more preferably from 4,000 to 7,000 and most preferably from 4,000 to 5,000. Water-soluble salts of such acrylic acid polymers can include, for example, the alkali metal, ammonium and substituted ammonium salts. Soluble polymers of this type are known materials. Use of polyacrylates of this type in detergent compositions has been disclosed, for example, in U.S. Pat. No. 3,308,067 to Diehl.

Acrylic/maleic-based copolymers may also be used as a preferred soil suspending polycarboxylic polymer. Such materials include the water-soluble salts of copolymers of acrylic acid and maleic acid. The average molecular weight of such copolymers in the acid form preferably ranges from 2,000 to 100,000, more preferably from 5,000 to 75,000, most preferably from 7,000 to 65,000. The ratio of acrylate to maleate segments in such copolymers will generally range from 30:1 to 1:1, more preferably from 10:1 to 2:1. Water-soluble salts of such acrylic acid/maleic acid copolymers can include, for example, the alkali metal, ammonium and substituted ammonium salts. Soluble acrylate/maleate copolymers of this type are known materials which are described in EP Application No. 66915. Particularly preferred is a copolymer of maleic/acrylic acid with an average molecular weight of 70,000. Such copolymers are commercially available from BASF under the trade name SOKALAN CP5.

Other suitable anti-resoiling polymers include those anti-resoiling polymers having: (a) one or more nonionic hydrophile components consisting essentially of (i) polyoxyethylene segments with a degree of polymerization of at least 2, or (ii) oxypropylene or polyoxypropylene segments with a degree of polymerization of from 2 to 10, wherein said hydrophile segment does not encompass any oxypropylene unit unless it is bonded to adjacent moieties at each end by ether linkages, or (iii) a mixture of oxyalkylene units comprising oxyethylene and from 1 to about 30 oxypropylene units wherein said mixture contains a sufficient amount of oxyethylene units such that the hydrophile component has hydrophilicity great enough to increase the hydrophilicity of conventional polyester synthetic fiber surfaces upon deposit of the soil release agent on such surface, said hydrophile segments preferably comprising at least about 25% oxyethylene units and more preferably, especially for such components having about 20 to 30 oxypropylene units, at least about 50% oxyethylene units; or (b) one or more hydrophobe components comprising (i) C₃ oxyalkylene terephthalate segments, wherein, if said hydrophobe components also comprise oxyethylene terephthalate, the ratio of oxyethylene terephthalate: C₃ oxyalkylene terephthalate units is about 2:1 or lower, (ii) C₄-C₆ alkylene or oxy C₄-C₆ alkylene segments, or mixtures therein, (iii) poly(vinyl ester) segments, preferably polyvinyl acetate), having a degree of polymerization of at least 2, or (v) C₁-C₄ alkyl ether or C₄ hydroxyalkyl ether substituents, or mixtures therein, wherein said substituents are present in the form of C₁-C₄ alkyl ether or C₄ hydroxyalkyl ether cellulose derivatives, or mixtures therein, and such cellulose derivatives are amphiphilic, whereby they have a sufficient level of C₁-C₄ alkyl ether and/or C₄ hydroxyalkyl ether units to deposit upon conventional polyester synthetic fiber surfaces and retain a sufficient level of hydroxyls, once adhered to such conventional synthetic fiber surface, to increase fiber surface hydrophilicity, or a combination of (a) and (b).

Typically, the polyoxyethylene segments of (a)(i) will have a degree of polymerization of from about 1 to about 200, although higher levels can be used, preferably from 3 to about 150, more preferably from 6 to about 100. Suitable oxy C₄-C₆ alkylene hydrophobe segments include, but are not limited to, end-caps of polymeric soil release agents such as MO₃S(CH₂)ₙOCH₂CH₂O—, where M is sodium and n is an integer from 4-6, as disclosed in U.S. Pat. No. 4,721, 580 to Gosselink.

Anti-resoiling polymers also include cellulosic derivatives such as hydroxyether cellulosic polymers, co-polymeric blocks of ethylene terephthalate or propylene terephthalate with polyethylene oxide or polypropylene oxide terephthalate, and the like. Such anti-resoiling polymers are commercially available and include hydroxyethers of cellulose such as METHOCEL (Dow). Cellulosic anti-resoiling polymers for use herein also include those selected from the group consisting of C₁-C₄ alkyl and C₄ hydroxyalkyl cellulose; see U.S. Pat. No. 4,000,093 to Nicol, et al. Anti-resoiling polymers characterised by poly(vinyl ester) hydrophobe segments include graft co-polymers of poly(vinyl ester), e.g., C₁-C₆ vinyl esters, preferably poly(vinyl acetate) grafted onto polyalkylene oxide backbones, such as polyethylene oxide backbones. See EP Application 0 219 048 to Kud, et al. Commercially available anti-resoiling polymers of this kind include the SOKALAN type of material, e.g., SOKALAN HP-220, available from BASF.

One type of preferred anti-resoiling polymers is a co-polymer having random blocks of ethylene terephthalate and polyethylene oxide (PEO) terephthalate. The molecular weight of this anti-resoiling polymers is in the range of from about 25,000 to about 55,000. See U.S. Pat. No. 3,959,230 to Hays and U.S. Pat. No. 3,893,929 to Basadur.

Another preferred anti-resoiling polymers is a polyester with repeat units of ethylene terephthalate units which contains 10-15% of ethylene terephthalate units together with 90-80% of polyoxyethylene terephthalate units, derived from a polyoxyethylene glycol of average molecular weight 300-5,000. Examples of this polymer include the commercially available material ZELCON 51260 (from Dupont) and MILEASE T (from ICI). See also U.S. Pat. No. 4,702,857 to Gosselink.

Another preferred anti-resoiling polymers agent is a sulfonated product of a substantially linear ester oligomer comprised of an oligomeric ester backbone of terephthaloyl and oxyalkyleneoxy repeat units and terminal moieties covalently attached to the backbone. These anti-resoiling polymers are fully described in U.S. Pat. No. 4,968,451 to Scheibel and Gosselink. Other suitable anti-resoiling polymers include the terephthalate polyesters of U.S. Pat. No. 4,711,730 to Gosselink et al, the anionic end-capped oligomeric esters of U.S. Pat. No. 4,721,580 to Gosselink, and the block polyester oligomeric compounds of U.S. Pat. No. 4,702,857 to Gosselink.

Preferred anti-resoiling polymers also include the soil release agents that are disclosed in U.S. Pat. No. 4,877,896 to Maldonado et al, which discloses anionic, especially sulfoaroyl, end-capped terephthalate esters.

Still another preferred anti-resoiling agent is an oligomer with repeat units of terephthaloyl units, sulfoisoterephthaloyl units, oxyethyleneoxy and oxy-1,2-propylene units. The repeat units form the backbone of the oligomer and are preferably terminated with modified isethionate end-caps. A particularly preferred anti-resoiling agent of this type comprises about one sulfoisophthaloyl unit, 5 terephthaloyl units, oxyethyleneoxy and oxy-1,2-propyleneoxy units in a ratio of from about 1.7 to about 1.8, and two end-cap units of sodium 2-(2-hydroxyethoxy)-ethanesulfonate. Said anti-resoiling agent also comprises from about 0.5% to about 20%, by weight of the oligomer, of a crystalline-reducing stabilizer, preferably selected from the group consisting of xylene sulfonate, cumene sulfonate, toluene sulfonate, and mixtures thereof. See U.S. Pat. No. 5,415,807 to Gosselink et al.

F. Builder and Buffering Agents

The cleaning composition may include a builder detergent, which increases the effectiveness of the surfactant. The builder detergent can also function as a softener and/or a sequestering and buffering agent in the cleaning composition. When employed, the builder detergent comprises at least about 0.001% and typically about 0.01-5% of the cleaning composition. A variety of builder detergents can be used and they include, but are not limited to, phosphate-silicate compounds, zeolites, alkali metal, ammonium and substituted ammonium polyacetates, trialkali salts of nitrilotriacetic acid, carboxylates, polycarboxylates, carbonates, bicarbonates, polyphosphates, aminopolycarboxylates, polyhydroxysulfonates, and starch derivatives.

Builder detergents can also include polyacetates and polycarboxylates. The polyacetate and polycarboxylate compounds include, but are not limited to, sodium, potassium, lithium, ammonium, and substituted ammonium salts of ethylenediamine tetraacetic acid, ethylenediamine triacetic acid, ethylenediamine tetrapropionic acid, diethylenetriamine pentaacetic acid, nitrilotriacetic acid, oxydisuccinic acid, iminodisuccinic acid, mellitic acid, polyacrylic acid or polymethacrylic acid and copolymers, benzene polycarboxylic acids, gluconic acid, sulfamic acid, oxalic acid, phosphoric acid, phosphonic acid, organic phosphonic acids, acetic acid, and citric acid. These builder detergents can also exist either partially or totally in the hydrogen ion form.

The builder agent can include sodium and/or potassium salts of EDTA and substituted ammonium salts. The substituted ammonium salts include, but are not limited to, ammonium salts of methylamine, dimethylamine, butylamine, butylenediamine, propylamine, triethylamine, trimethylamine, monoethanolamine, diethanolamine, triethanolamine, isopropanolamine, ethylenediamine tetraacetic acid and propanolamine.

Buffering and pH adjusting agents, when used, include, but are not limited to, organic acids, mineral acids, alkali metal and alkaline earth salts of silicate, metasilicate, polysilicate, borate, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and 2-amino-2methylpropanol. Preferred buffering agents for compositions of this invention-are nitrogen-containing materials. Some examples are amino acids such as lysine or lower alcohol amines like mono-, di-, and tri-ethanolamine. Other preferred nitrogen-containing buffering agents are tri(hydroxymethyl)amino methane (HOCH₂)₃CNHH₃ (TRIS), 2-amino-2-ethyl-1,3-propanediol, 2-amino-2-methyl-propanol, 2-amino-2-methyl-1,3-propanol, disodium glutamate, N-methyl diethanolamide, 2-dimethylamino-2-methylpropanol (DMAMP), 1,3-bis(methylamine)-cyclohexane, 1,3-diamino-propanol N,N′-tetra-methyl-1,3-diamino-2-propanol, N,N-bis(2-hydroxyethyl)glycine(bicine) and N-tris(hydroxymethyl)methyl glycine (tricine). Other suitable buffers include ammonium carbarnate, citric acid, acetic acid. Mixtures of any of the above are also acceptable. Useful inorganic buffers/alkalinity sources include ammonia, the alkali metal carbonates and alkali metal phosphates, e.g., sodium carbonate, sodium polyphosphate. For additional buffers see McCutcheon's Emulsifiers and Detergents, North American Edition, 1997, McCutcheon Division, MC Publishing Company Kirk and WO 95/07971.

G. Additional Adjuncts

The cleaning composition optionally contains one or more of the following adjuncts: stain blocking agents, stain and soil repellants, enzymes, lubricants, insecticides, odor control agents, fragrances and fragrance release agents, brighteners or fluorescent whitening agents, oxidizing or reducing agents, polymers which leave a film to trap or adsorbs bacteria, virus, mite, allergens, dirt, dust, or oil.

The cleaning composition may includes additional adjuncts. The adjuncts include, but are not limited to, fragrances or perfumes, waxes, dyes and/or colorants, solubilizing materials, stabilizers, thickeners, defoamers, hydrotropes, lotions and/or mineral oils, enzymes, bleaching agents, cloud point modifiers, preservatives, and other polymers. The waxes, when used, include, but are not limited to, carnauba, beeswax, spermacet, candelilla, paraffin, lanolin, shellac, esparto, ouricuri, polyethylene wax, chlorinated naphthaline wax, petrolatu, microcrystalline wax, ceresine wax, ozokerite wax, and/or rezowax. The solubilizing materials, when used, include, but are not limited to, hydrotropes (e.g. water soluble salts of low molecular weight organic acids such as the sodium and/or potassium salts of xylene sulfonic acid). The acids, when used, include, but are not limited to, organic hydroxy acids, citric acids, keto acid, and the like. Thickeners, when used, include, but are not limited to, polyacrylic acid, xanthan gum, calcium carbonate, aluminum oxide, alginates, guar gum, methyl, ethyl, clays, and/or propylhydroxycelluloses. Defoamers, when used, include, but are not limited to, silicones, aminosilicones, silicone blends, and/or silicone/hydrocarbon blends. Lotions, when used, include, but are not limited to, achlorophene and/or lanolin. Enzymes, when used, include, but are not limited to, lipases and proteases, and/or hydrotropes such as xylene sulfonates and/or toluene sulfonates. Bleaching agents, when used, include, but are not limited to, peracids, hypohalite sources, hydrogen peroxide, and/or sources of hydrogen peroxide.

Preservatives, when used, include, but are not limited to, mildewstats or bacteriostats, methyl, ethyl and propyl parabens, short chain organic acids (e.g. acetic, lactic and/or glycolic acids), bisguanidine compounds (e.g. DANTAGARD and/or GLYDANT) and/or short chain alcohols (e.g. ethanol and/or IPA).

Mildewstats or bacteriostats include, but are not limited to, mildewstats (including non-isothiazolone compounds) include Kathon GC, a 5-chloro-2-methyl-4-isothiazolin-3-one, KATHON ICP, a 2-methyl-4-isothiazolin-3-one, and a blend thereof, and KATHON 886, a 5-chloro-2-methyl-4-isothiazolin-3-one, all available from Rohm and Haas Company; BRONOPOL, a 2-bromo-2-nitropropane 1,3 diol, from Boots Company Ltd., PROXEL CRL, a propyl-p-hydroxybenzoate, from ICI PLC; NIPASOL M, an o-phenyl-phenol, sodium salt, from Nipa Laboratories Ltd., DOWICIDE A, 6a 1,2-Benzoisothiazolin-3-one, from Dow Chemical Co., and IRGASAN DP 200, a 2,4,4′-trichloro-2-hydroxydiphenylether, from Ciba-Geigy A.G.

Experimental Results

To test the efficacy of the cleaning composition containing glycol ether, glycol ether ester, and combinations thereof for their ability to kill dust mites, a submersion method was used. The dust mites were immersed in the following solutions with a 1% or 8% glycol ether, glycol ether ester or a combination thereof. In addition to the glycol ether and or glycol ether ester, the solution also contained about 1% Stepanol® WAC (sodium lauryl sulfate) surfactant and the remainder of the solution was water. The pH of the aqueous solution was maintained between about 5 to 10.

After the dust mites were immersed in the solution they were tested each minute to determine if they were still alive or not. To test if the mites were alive after treatment, they are viewed under a dissecting microscope and poked with a 26-guage needle to induce movement. If the mites moved after being poked they were preliminarily determined to still be alive and if they did not move they were preliminarily determined to be dead. Since sometimes dust mites may appear to-be dead after treatment and then recover a few days later, a treated population and a control sample were placed in a high humidity desiccators and poke tests were conducted over several days following the initial treatment to ensure that the initial reported kill rates were accurate.

The data clearly demonstrates that the glycol ether cleaning solutions are capable of a high kill rate of dust mites in a relatively short period of time. For many of the solutions the kill rate was over 80% after approximately 20 minutes and a number of the solutions have a 100% kill rate well under 30 minutes.

Results:

TABLE 1
Hydrophobic Solvent Dust Mite Kill Efficacy Summary

| | | | | | 1% HC | | 1% HC |
|---|---|---|---|---|---|---|---|
| | | | | | with 7% | | with 7% |
| | 8% | | 1% HC | | DPnP | | DpnP at |
| Product | Solution | | Solution | pH | Solution | pH | 9.5 pH |
| Hexyl | 11 | min | 15 min | 6.86 | 14 min | 7.18 | 26 min |
| Cellosolve | | | | | | | |
| Butyl | 4 | min | 22 min | 6.30 | 18 min | 5.99 | 16 min |
| Cellosolve | | | | | | | |
| Acetate | | | | | | | |
| Dowanol | 7 | min | 22 min | 7.26 | 30 min | 7.35 | 26 min |
| PPh | | | | | | | |
| Dowanol | 17 | min | 95% kill | 7.28 | 95% kill | 7.41 | 50% kill |
| Eph | | | at | | at | | at |
| | | | 30 min | | 30 min | | 30 min |
| Butyl | 20 | min | 50% kill | 6.25 | 90% kill | 5.97 | 80% kill |
| Carbitol | | | at | | at | | at |
| Acetate | | | 30 min | | 30 min | | 30 min |
| Dowanol | 17 | min | None | 7.25 | 29 min | 7.34 | 60% kill |
| PnB | | | | | | | at |
| | | | | | | | 30 min |
| Downaol | 25 | min | None | 7.22 | 30 min | 7.30 | No kill |
| DPnB | | | | | | | |
| Hexyl | 25 | min | None | 6.79 | 26 min | 7.02 | No kill |
| Carbitol | | | | | | | |
| Dowanol | 20 | min | None | 7.23 | 90% kill | 7.18 | No kill |
| TPnB | | | | | at | | |
| | | | | | 30 min | | |

| | | | | | | |
|---|---|---|---|---|---|---|
| Proglyde | 85% at | None | 7.51 | 50% kill | 7.33 | 10% kill |
| DMM | 30 min | | | at | | at |
| | | | | 30 min | | 30 min |

100% kill at indicated time unless noted. Maximum time period 30 minutes.
** Solutions also contain 1% Stepanol ® WAC surfactant (sodium lauryl sulfate)

The experimental results of the dust mite kill efficacy summary showed that the hydrophobic properties and vapor pressure of the solvents were critical to the effectiveness as a miticide. The preferred vapor pressure of the solvents is less than about 1 mm Hg at 20° C., and preferably the vapor pressure is less than 0.5 mm Hg at 20° C. Insects have an oily layer on their bodies to protect them and the hydrophobic solvents are better able cut through that oily layer. The second important factor for the solvent is its evaporation rate because if it is too high the solvent does not have enough time to kill the mites before it evaporates. Therefore the fast evaporation solvents had lower kill rates on average than the solvents with slower evaporation rates. The solvents with moderate evaporation rates appear to be the more effective miticides than the slow evaporation solvent because they are better grease cutters.

The following chart shows that the glycol ether or glycol ether ester solution is most effective as a miticide if it its solubility in water a 20° C. is less than 50%, preferably less than 25%, and most preferably less than 15%. Similarly effective the cleaning solutions have a vapor pressure of less than 1 mm Hg at 20° C., more preferably less than 0.25 mm Hg at 20° C., most preferably less than 0.1 mm Hg at 20° C.

TABLE 2

| | | | >50% |
|---|---|---|---|
| | Solubility | Vapor | kill |
| | in water at | Pressure | in 30 |
| 8% or saturated solutions in water | 20° C. | (mm Hg) | min. |
| Diethylene glycol methyl ether | 100% | 0.2 | no |
| Diethylene glycol ethyl ether | 100% | 0.12 | No |
| Ethylene glycol n-propyl ether | 100% | 1.3 | No |
| Ethylene glycol n-butyl ether | 100% | 0.6 | No |
| Diethylene glycol n-butyl ether | 100% | 0.02 | No |
| Ethylene glycol n-hexyl ether | 1% | <1.0 | Yes |
| Ethylene glycol n-butyl ether acetate | 1% | 0.29 | Yes |
| Diethylene glycol n-butyl ether acetate | 6% | 0.04 | Yes |
| Propylene glycol methyl ether | 100% | 8.1 | No |
| Dipropylene glycol methyl ether | 100% | 0.17 | No |
| Tripropylene glycol methyl ether | 100% | 0.03 | No |
| Propylene glycol methyl ether acetate | 18% | 3.8 | No |
| Dipropylene glycol methyl ether acetate | 12% | 0.05 | Yes |
| Propylene glycol n-propyl ether | 100% | 1.8 | No |
| Dipropylene glycol n-propyl ether | 18% | 0.05 | No |
| Propylene glycol n-butyl ether | 6% | 0.62 | Yes |
| Dipropylene glycol n-butyl ether | 5% | 0.02 | Yes |
| Tripropylene glycol n-butyl ether | 3% | <0.01 | Yes |
| Example A (aerosol formula containing | | | Yes |
| Dipropylene glycol n-propyl ether) | | | |

Cleaning Methods

In one of the embodiments of the invention, the cleaning formula is used with a lightweight mopping device including a pole, a handle with a trigger, a cleaning head assembly with a cleaning pad, a holster and spray canister for supplying the cleaning formula. The cleaning fluid preferably in aerosol form is applied by trigger activation onto the surface to be cleaned. The cleaning head assembly may contain various kinds of cleaning tools, including but not limited to, wipes, pads, sponges, brushes, rakes and any other appropriate tool.

The cleaning head assembly has a cleaning pad preferably fabricated of absorbent and/or absorbent materials. Once the cleaning fluid has been applied to the surface to be cleaned the surface may be wiped or scrubbed with a cleaning pad to facilitate in cleaning and also to remove some of the remaining fluid. After the surface has been wiped clean it may be vacuumed to remove any final particles or leftover fluid.

In the case where the cleaning pads are made of an absorbent material, the cleaning composition may include an effective amount of release agent to increase the amount of cleaning components, e.g., polymeric stain removing agents, released from the cleaning pad and onto the surface to be cleaned. The release agent is preferably an ionic species designed to compete with the polymer for sites on the cleaning pad thereby causing increased polymer release from the cleaning pad during use. The release agent may include a salt. A variety of different salts can be used such as, for example, monovalent salts, divalent salts, organic salts, and the like. Preferably, the effective ionic strength of the release agent in the cleaning composition is at least about 5×10⁻³ mol/l.

A variety of chemical adjuncts/additives may be incorporated into the pad itself. These additives may be sprayed on or otherwise applied. They may be incorporated as part of the fiber materials. They may be encapsulated or imbedded in the pad materials, for example, as described in WO2002102331 to Alwattari et al. The cleaning pad may have optional additives on the pad, which either interact with the cleaning formula or transfer to the surface to be cleaned. In addition to the miticide and anti-allergen formula, other optional additives may include, for instance, soil and stain resist agents, abrasives, antifoam agents, lubricants to enhance glide, dirt attracting polymers, odor absorbing agents, and/or wetting agents, which are further described herein.

The adjuncts/additives that are incorporated directly into the cleaning pad prior to use or indirectly as part of the cleaning composition during use can be encapsulated for delayed effect. For example, fragrance that is encapsulated and deposited on the carpet becomes “activated” when the capsules are broken by mechanical action e.g., friction from foot traffic, or dissolved by chemical means, e.g., oxidation or light triggered. As another example, encapsulated peroxide can be used for sustained release on the carpet surface. The capsules can be formulated to activate on contact with water from the soil. This ensures that oxidation and soil breakdown start on contact with the carpet surface. Encapsulation can be accomplished by coating the adjunct with the appropriate materials. Typically, the coating material will comprise polymeric materials.

In another embodiment of the invention, the cleaning solution may be used to clean laundry either prior to or concurrent with either the washing or drying process. The cleaning solution may be in many forms, such as, a liquid spray, a liquid solution, an aerosol spray, a cleaning stick, a roll-on applicator, a dryer sheet, dry cleaning pad and any other appropriate means of applying the cleaning solution. In the case of a dryer sheet or other similar delivery mechanism, the heat of the dryer is utilized to thermally evaporate the cleaning solution so that it comes in contact with the various articles of clothing, linens or other articles being cleaned.

In a further embodiment of the invention, the cleaning solution is used with an emanator for air treatment. The emanator may utilize a fan for diffusing the cleaning solution, a plug-in device, a wicking device, a fogger, a heater for evaporating or may use electrostatic vaporization or any other suitable means for air treatment.

We claim:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. A method of controlling dust mites and allergens in the air, said method comprising the step of evaporating or vaporizing into the air a composition comprising a solvent selected from a group consisting of a glycol ether, a glycol ether ester, or combination thereof.

26. The method of claim 25, wherein one of said glycol ether or glycol ether ester has less than about 50% solubility in water at 20° C.

27. The method of claim 25, wherein one of said glycol ether or glycol ether ester has less than about 25% solubility in water at 20° C.

28. A method of treating the air to control allergens in an enclosed area, said method comprising the step of evaporating or vaporizing into the air a composition comprising a glycol ether, a glycol ether ester, or combination thereof, wherein one of said glycol ether or glycol ether ester has less than about 15% solubility in water at 20° C.; and a vapor pressure of less than about 1 mm Hg at 20° C.

29. A method of treating the air to control allergens in an enclosed area, said method comprising the step of evaporating or vaporizing into the air a composition comprising a glycol ether, a glycol ether ester, or combination thereof.

30. The method of claim 29, wherein the glycol ether or glycol ether ester has less than about 15% solubility in water at 20° C.

31. The method of claim 29, wherein the method utilizes an aerosol dispenser.

32. The method of claim 29, wherein the method utilizes a device having electrostatic vaporization.

33. The method of claim 29, wherein the method utilizes an emanator device.

34. The method of claim 33, wherein the emanator includes a device selected from the group consisting of a fan, a wicking device, a plug-in device, a heater, or combinations thereof.

35. The method of claim 29, wherein the composition comprises an ethylene glycol ether or diethylene glycol ether.

36. The method of claim 29, wherein the composition comprises glycol ether selected from the group consisting of a propylene glycol ether, dipropylene glycol ether, a tripropylene glycol ether and combinations thereof.

37. The method of claim 29, wherein the composition comprises a glycol ether acetate.

38. The method of claim 29, wherein the composition comprises a glycol ether.

39. The method of claim 29, wherein the composition comprises dipropylene glycol propyl ether.
